(19) United States
(12) Patent Application Publication
(10) Pub. No.: US 2009/0317218 A1
(43) Pub. Date: Dec. 24, 2009

(54) Container tilter

(75) Inventors: John Phelps, Roland, AR (US); Don K. Chapman, Cabot, AR (US); Daniel L. Darcey, Little Rock, AR (US)

Correspondence Address: SPEED LAW FIRM, 111 CENTER STREET, SUITE 1200, LITTLE ROCK, AR, 72201, US

(73) Assignee: Phelps Industries, Inc., Little Rock, AR (US)

(21) Appl. No.: 12/583,693

(22) Filed: Aug. 25, 2009

Related U.S. Application Data
(63) Continuation-in-part of application No. 11/508,727, filed on Aug. 23, 2006.
(60) Provisional application No. 61/190,012, filed on Aug. 25, 2008.
(60) Provisional application No. 60/710,931, filed on Aug. 23, 2005.

(51) Int. Cl. B65G 67/04

(52) U.S. Cl. 414/401; 414/809

(57) ABSTRACT

Embodiments generally include a container tilter and method of tilting and/or loading a container which are more efficient and time and cost effective than previous apparatus and methods. Embodiments further include a backstop apparatus and method of using which allow for more effective, efficient, and time and cost savings in loading a container than previous methods and container loading apparatus. Additional embodiments include a weighing apparatus and method which provide efficient and time and cost effective weighing of materials within a container during loading and/or at one or more time intervals of the container loading process.

### CROSS-REFERENCE TO RELATED APPLICATIONS

This application claims benefit of U.S. provisional patent application Ser. No. 61/190,012, filed Aug. 25, 2008, which is herein incorporated by reference. This application is also a continuation-in-part of co-pending U.S. patent application Ser. No. 11/508,727, filed Aug. 23, 2006, which claims benefit of U.S. provisional patent application Ser. No. 60/710,931, filed Aug. 23, 2005. Each of the aforementioned related patent applications is herein incorporated by reference.

### BACKGROUND OF THE INVENTION

1. Field of the Invention

Embodiments generally relate to container tilters.

2. Description of the Related Art

Trailer tippers and related low profile, portable trailer tippers are known in the art. Examples of a few such tippers are disclosed in U.S. Pat. Nos. 5,458,451 and 6,019,568, each of which is incorporated herein by reference in its entirety. Trailer tippers are also described in U.S. Pat. No. 6,860,695 issued on Mar. 1, 2005 (hereinafter “'695 patent”), which is also incorporated by reference in its entirety. In particular, FIGS. 7-10 of the '695 patent depict various views of a trailer tipper. A typical trailer tipper includes a sub-frame and a deck pivotally secured to a rear portion of the sub-frame.

A container into which one or more materials are loaded is usually attached to the chassis of a truck for transporting the container to a location for loading materials into the container. To load the one or more materials into the container is an often tortuous, inefficient, and time-consuming procedure involving detaching the container from the chassis when the unit is lifted to be loaded, rotating the container 180 degrees to load the container, and separately weighing the contents of the container by unloading the container from the container tilter and weighing the container on a separate scale.

There is therefore a need for an efficient and convenient method and apparatus for loading one or ore materials into a container.

### SUMMARY OF THE INVENTION

Embodiments generally include a container tilter and method of tilting and/or loading a container which are more efficient and time and cost effective than previous apparatus and methods. Embodiments further include a backstop apparatus and method of using which allow for more effective, efficient, and time and cost savings in loading a container than previous methods and container loading apparatus. Additional embodiments include a weighing apparatus and method which provide efficient and time and cost effective weighing of materials within a container during loading and/or at one or more time intervals of the container loading process.

Some embodiments may include an apparatus for loading one or more materials in a container disposed on a chassis, comprising a sub-frame; a deck pivotally connected to the sub-frame; one or more members for pivoting the deck relative to the sub-frame; and an adjustable backstop assembly operatively connected to the deck for selectively retaining the container on the deck when a container and chassis are disposed on the deck and the deck is pivoted relative to the sub-frame. Other embodiments may include a method of loading one or more materials into a container disposed on a chassis, comprising providing a container tilting apparatus comprising a sub-frame, a deck pivotally connected to the sub-frame, a pivoting member for pivoting the deck relative to the sub-frame, and a backstop assembly moveable between a first position and a second position; moving the container and chassis onto the deck through the backstop assembly while the backstop assembly is in the first position; moving the backstop assembly from the first position to the second position; pivoting the deck relative to the sub-frame using the pivoting member; and retaining the container and chassis on the deck using the backstop assembly in the second position. Further embodiments may include an apparatus for loading one or more materials in a container disposed on a chassis, comprising a sub-frame; a deck pivotally connected to the sub-frame; one or more members for pivoting the deck relative to the sub-frame; and an adjustable backstop assembly operatively connected to the deck for selectively retaining the container on the deck, the backstop assembly comprising a support member which is generally stationary relative to the deck, and a slide member which is slidable relative to the support member between a first position and a second position, the slide member capable of retaining the container on the deck upon pivoting of the deck relative to the sub-frame when the slide member is in the first position.

### BRIEF DESCRIPTION OF THE DRAWINGS

So that the manner in which the above-recited features of embodiments of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a side elevation view of a container tilter in position ready for use with the deck platform in a lowered position.

FIG. 2 is a downward view of the container tilter of FIG. 1.

FIG. 3 is a side elevation view of the container tilter of FIG. 1 with a container on the deck platform and the deck in a raised position.

FIG. 4 is a perspective view of a load pin capable of use with the container tilter of FIG. 1.

FIG. 5 shows detailed section views of a backstop of the container tilter of FIG. 1.

FIG. 6 shows detailed section views of a backstop assembly of the container tilter of FIG. 1.

FIG. 7 shows detailed section views of a container lock assembly of the container tilter of FIG. 1.

FIG. 8 shows detailed section views of A-frames of the container tilter of FIG. 1.

FIG. 9 shows a section view of the container tilter of FIG. 1 including a container locking link.

FIG. 10 shows a perspective section view of the container tilter of FIG. 1 including one or more load pins.

FIG. 11 is a first end view of the container tilter of FIG. 1 with a container disposed therein.

### DETAILED DESCRIPTION

Co-pending U.S. patent application Ser. No. 11/508,727 having the inventor Don K. Chapman and filed on Aug. 23, 2006, published as U.S. Patent Publication No. 2007/0065260 on Mar. 22, 2007 (hereinafter “the '727 application), is herein incorporated by reference in its entirety. Furthermore, U.S. Provisional Application No. 60/710,931, filed on Aug. 23, 2005, is also incorporated by reference herein in its entirety. Many of the components and procedures related to the trailer tipper 10 of the '727 application and its added features are similar to the container tilter of the present application; therefore, the disclosure of the trailer tipper 10 apparatus and methods of the '727 application may be applicable to embodiments of the present invention, especially description related to components with like numbers in the '727 application and the present application.

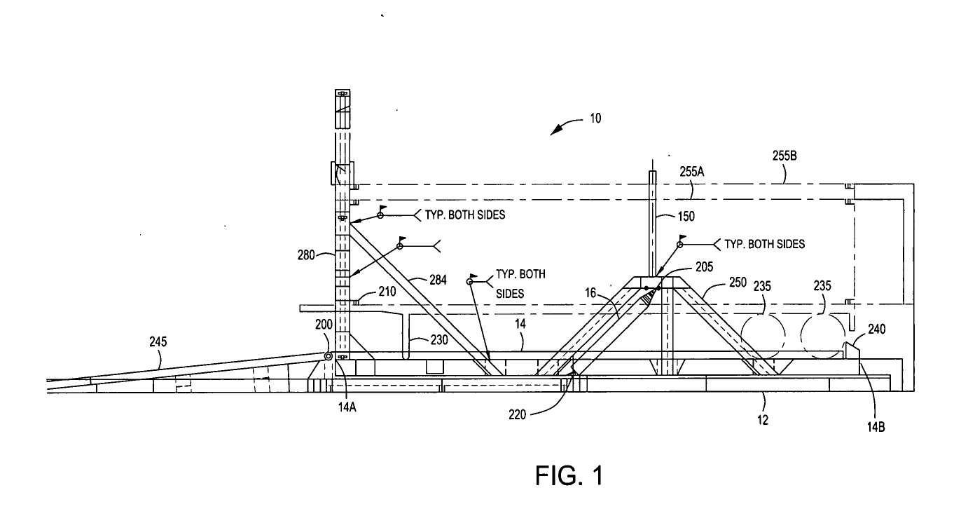

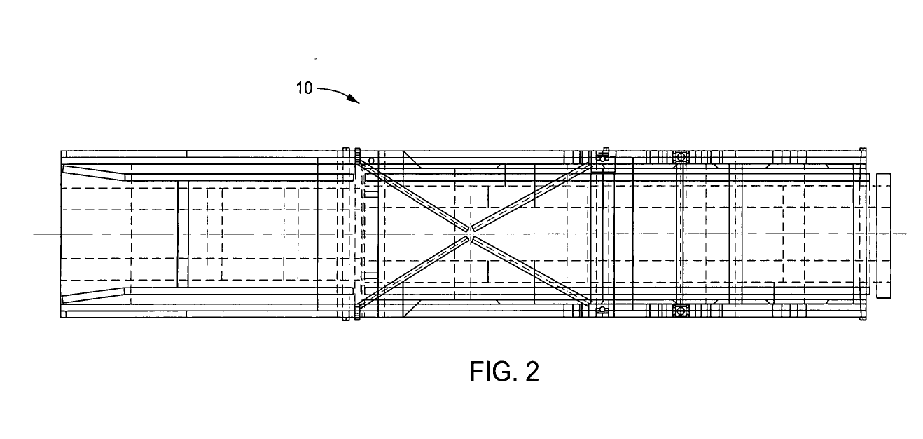

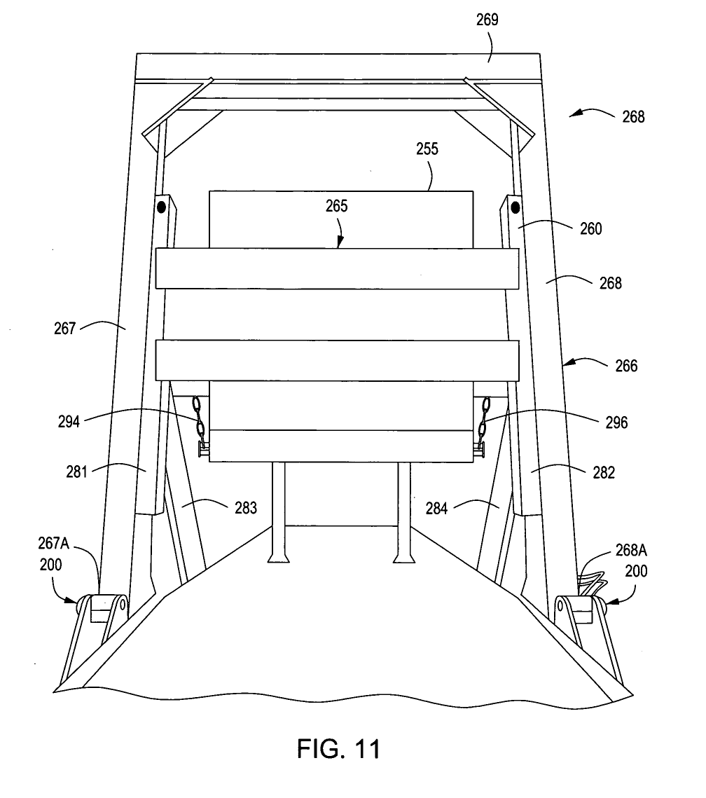

FIGS. 1-3 and 11 show a container tilter 10 of embodiments of the present invention. The container tilter 10 includes a sub-frame 12, a deck 14 or deck platform pivotally secured to an end portion of the sub-frame 12, and a means or member 16 for raising the deck 14 relative to the sub-frame 12, such as one or more hydraulic cylinders or actuators or a piston/cylinder assembly. An adjustable backstop assembly 280 is secured to the deck 14 (and/or sub-frame 12) at or near its first end 14A. A ramp 245, which may include a fixed ramp, may be pivotally mounted at or near the end portion of the sub-frame 12.

The means or member 16 for raising and lowering the deck 14 relative to the sub-frame 12 is shown in FIGS. 1-3 as one or more cylinders mounted at or near their respective upper ends via one or more top cylinder mounts 225 to a portion of one or more A-frames 250 and at or near their respective lower ends to the sub-frame 12 via one or more bottom cylinder mounts 220. Lower ends of the one or more A-frames 250 are operatively connected to the deck 14.

In one embodiment, the deck 14 may include one or more beams and cross-beams operatively connected to a lower surface of a platform onto which the container and chassis are loaded (see below), the beams and cross-beams providing additional support for the container and chassis when they are disposed on the platform.

A safety hoop 150, which may be constructed and may operate generally as shown and described in the '727 application or as any other safety hoop known to those skilled in the art, may be operatively connected to an upper portion of the one or more A-frames 250 to provide support for one or more containers 255A or 255B disposed on the container tilter 10. One or more rear support structures such as one or more wheel stops or wheel chocks 240 are optionally disposed at a second end 14B of the deck 14 to provide a halting mechanism and stop position indicator for the chassis and container 225A or 225B to signify when the container 225A or 225B is disposed on the deck 14 in the proper position for tilting and/or prevent the container 225A or 225B from exiting the container tilter 10 when the deck is in the tilted position, typically for loading the container 225A or 225B.

Shown by the dotted lines in FIG. 1 are two different sizes of containers 225A or 225B, including a standard container 225A and a tall container 225B (approximate dimensions of the standard and tall containers may be approximately 8 feet, six inches tall and nine feet, six inches tall, respectively, and approximately 40 feet in length). These sizes of containers are merely exemplary of the containers which may be disposed within the container tilter 10 and are not limiting of the dimensions and sizes of containers which may be utilized with the container tilter 10. Similarly, the dimensions described with respect to FIGS. 1-8 are merely exemplary of component dimensions and therefore not limiting to the scope of embodiments. The container 225A or 225B may be a seagoing container.

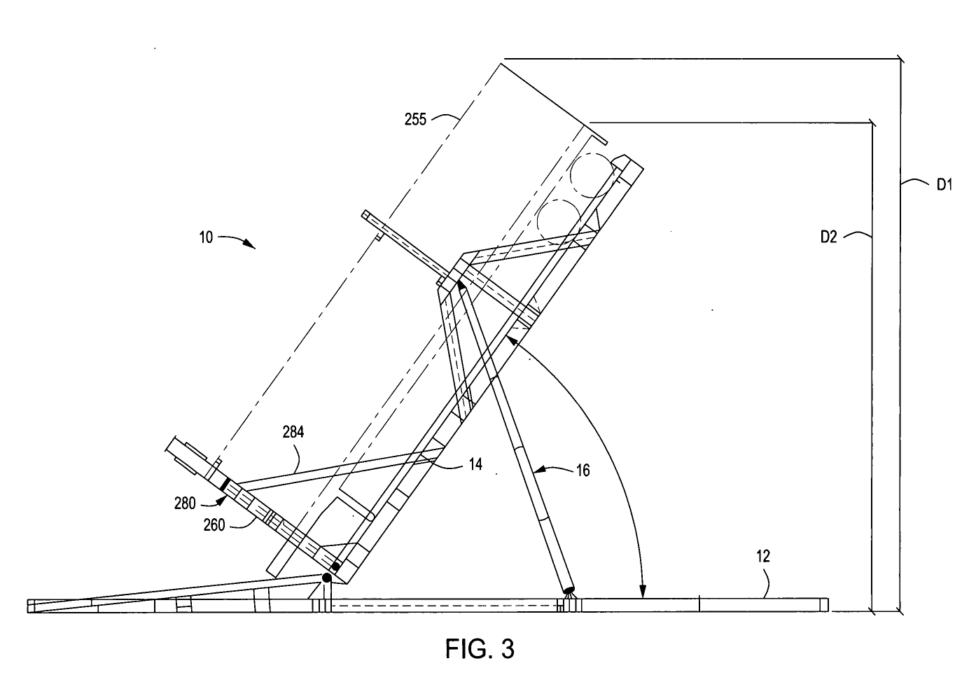

The backstop assembly 280 may be hydraulically, pneumatically, mechanically, and/or electrically operated and powered, e.g., in a manner and with powering components similar to the backstop assembly 20 shown and described in the '727 application. The backstop assembly 280 includes a slide gate 260 for supporting a container 255A or 255B disposed within, on, or in the container tilter 10 when the deck 14 is located in the tilted position (see FIG. 3). The backstop assembly 280 may also include a gate supporting member 266 relative to which the slide gate 260 is capable of sliding.

The gate supporting member 266 may be pivotable with respect to the sub-frame 14 via one or more pivot points, which may include pivot bearings 200. However, with respect to its longitudinal position relative to the deck 14 and sub-frame 12, the gate supporting member 266 may remain stationary. The gate supporting member 266 may include one or more beam members, for example a first beam member 267 disposed generally parallel to a second beam member 268. The first beam member 267 and second beam member 268 may be pivotally connected to the sub-frame 12 at or near their first ends 267A and 268A. The gate supporting member 266 may also include one or more cross members 269, which may be one or more cross-beams. The one or more cross members 269 may operatively connect the first member 267 and second member 268 to one another, e.g., by a first end 269A of the cross member 269 being operatively connected to a portion of the first member 267 (e.g., at or near a second end 267B of the first member 267) and a second end 269B of the cross member being operatively connected to a portion of the second member 268 (e.g., at or near a second end 268B of the second member 268). The cross member(s) 269 may be generally perpendicularly disposed relative to the first and second members 267 and 268, being generally horizontally aligned to be disposed generally parallel to the deck 14. In the alternative, the one or more cross members 269 may be generally vertically (longitudinally) or diagonally aligned or arranged in any other fashion which allows the container 255A or 255B to enter and exit the container tilter 10 through the gate supporting member 266 and adequately supports the slide gate 260 as well as the gate supporting member 266 structure.

The slide gate 260 may include one or more beam members, for example a first beam member 281 disposed generally parallel to a second beam member 282. Additionally, one or more container-supporting members 265, which may include one or more cross beams, may be associated with the backstop assembly 280 to support the container 255A or 255B when the slide gate 260 is in the container-supporting position. The one or more container-supporting members 265 may be generally horizontally aligned to be disposed generally parallel to the deck 14, or instead may be generally vertically or diagonally aligned or arranged in any other fashion where the one or more container-supporting members 265 adequately support the weight of the container 225A or 225B when the deck 14 is in a tilted position or being tilted. The backstop/gate 260 of the backstop assembly 280 may be moveable upward to an up position to allow the container 255, 255A, or 255B and chassis to back onto the container tilter 10 and downward to a down position to support the container 255, 255A, or 255B when it is disposed within the container tilter 10 (for example, when the container tilter 10 is in the tilted position as shown in FIG. 3 where the deck 14 is pivoted with respect to the sub-frame 12). The first member 281 and second member 282 (and container-supporting members 265) may be slidable relative to the first member 267 and second member 268 via hydraulic or other methods of powering sliding action of the slide gate 260. FIG. 1 shows the position of the backstop when the container is ready to be raised and when backing the container onto the deck.

The backstop assembly 280 and/or the container 255A or 255B may be stabilized and structurally supported on the container tilter 10 via one or more braces 283, 284. The braces 283, 284 may be operatively connected at or near one end to the backstop assembly 280 and at or near one end to the deck 14.

To raise or lower the backstop/gate of the backstop assembly 280, a hydraulic connection may exist from the sub-frame 12 to the hydraulic controls. The controls preferably include one or more digital indicators (or other types of indicators known to those skilled in the art) for showing control data and one or more motors for moving or sliding the backstop/gate, and may include one or more memory and/or computation members or means, e.g., one or more computers for receiving and calculating control data, one or more data conversion members or means, and/or one or more outputting members or means for supplying the data to a display.

FIG. 1 shows two different-sized hypothetical containers 255A and 255B located on the deck platform 14. The containers 255A and 255B are disposed on a chassis, which may include one or more legs 230 and/or one or more wheels 235. The chassis is used to transport the container (which may be a seagoing container) from one location to another. The one or more wheels 235 may ultimately be positioned to generally abut the one or more wheel chocks 240, while the one or more legs 230 may reside near the first end of the deck 14A. FIG. 3 shows the container 255 on the chassis in the tilted position and supported by the backstop assembly 280. As is obvious from FIGS. 1 and 3, the container may remain on its chassis while it is loaded onto the container tilter, tilted, and loaded with material, rather than the requirement of previous container tilters to remove the container 255 from the chassis prior to its loading onto the container tilter 10. Additionally, the container 255 is capable of being loaded onto the container tilter 10, being tilted, and having material loaded therein without requiring that the container 255 be removed from the container tilter 10 and turned around 180 degrees, as is required with prior apparatus and methods for loading containers. Essentially, in embodiments, the container and chassis may be advantageously handled as one integral piece, allowing tilting of this “piece” to any given angle.

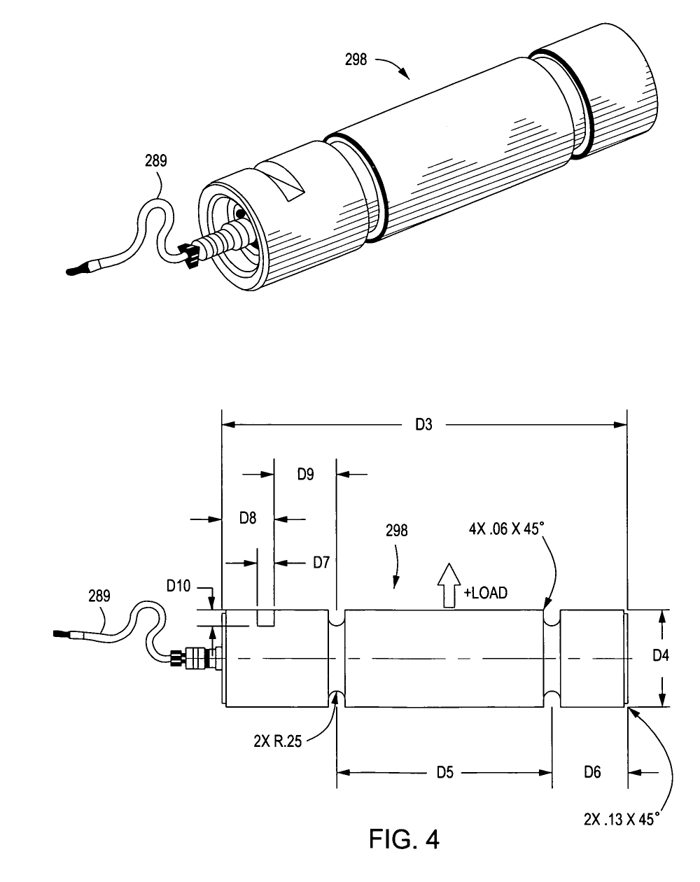

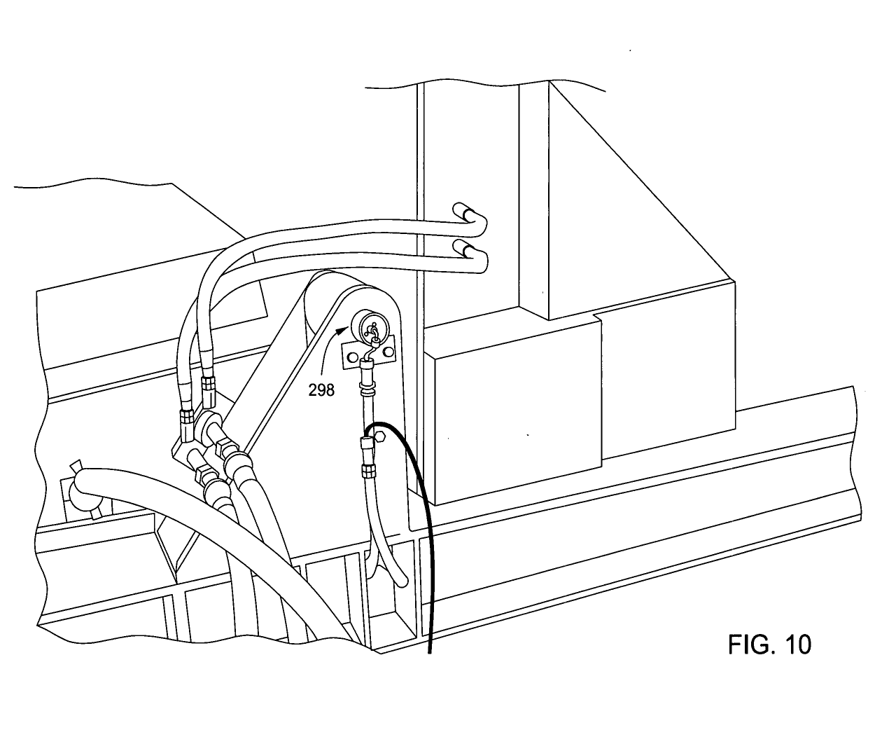

An integral scale to the container tilter may be incorporated within, into, or with the sub-frame 12 and/or deck platform 14 to weigh the container 255A or 255B and the material disposed within the container 255A or 255B, thereby allowing weighing of the material in real time while loading the container 255A or 255B with the material rather than requiring the container to be removed from the container tilter 10 periodically and separately weighed. The scale system may pin in between the sub-frame 12 and the deck platform 14, with a special pivot design to accommodate the scale system denoted by the one or more pivot bearings 200 and the one or more bottom cylinder mounts 220. An exemplary load pin 298 which may be used at the bottom cylinder mounts 220 and pivot bearings 200 is shown in FIG. 4. Exemplary dimensions and technical specifications of the load pin are disclosed in FIG. 4 of U.S. Provisional Application No. 61/190,012, which application was incorporated herein by reference above. (Similarly, exemplary dimensions of other components shown and described herein are disclosed in U.S. Provisional Application No. 61/190,012, which application was incorporated herein by reference above.) FIG. 10 also shows a perspective view of the load pin 298 with reference to other components of embodiments. The pin 298 may include one or more connectors 289 which may electrically connect the pin 298 to one or more readout panels of the scale to show weight on one or more digital indicators. The one or more readout panels and one or more digital indicators may be those that are typically used in weighing containers with materials therein, which readout panels and digital indicators are known to those skilled in the art. In one embodiment, a total of four load pins 298 are operatively connected to the container tilter 10 at the bottom cylinder mounts 220 and pivot bearings 200.

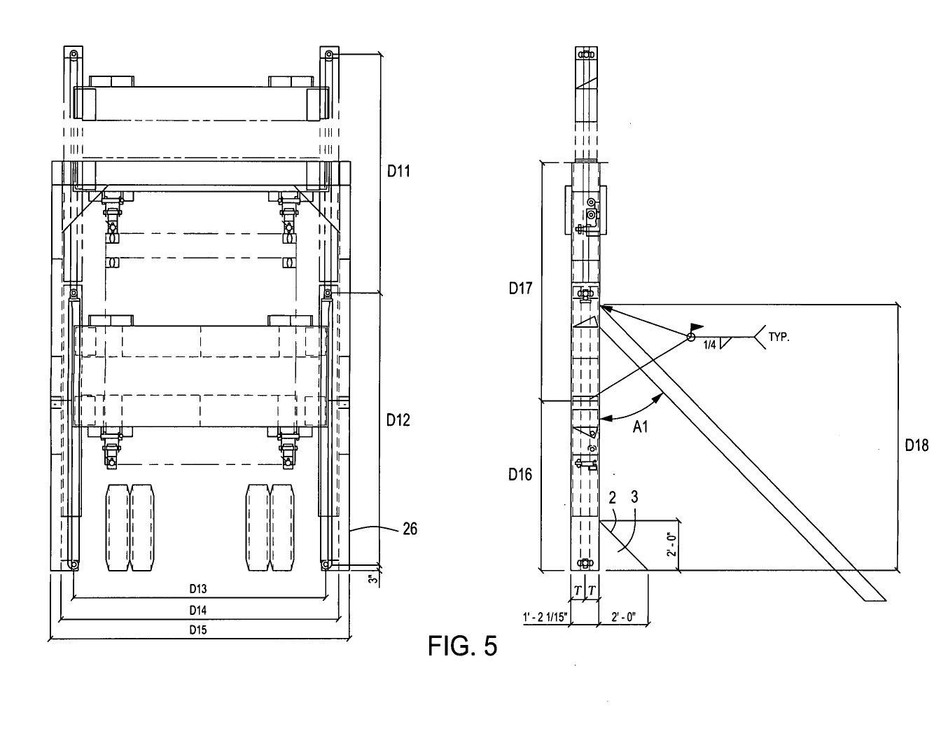

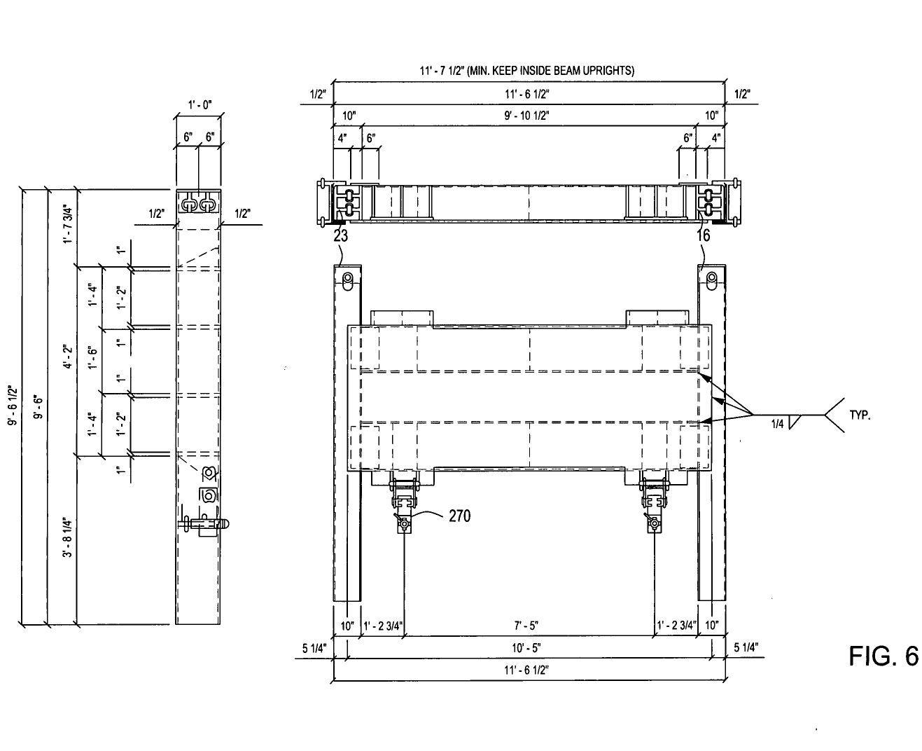

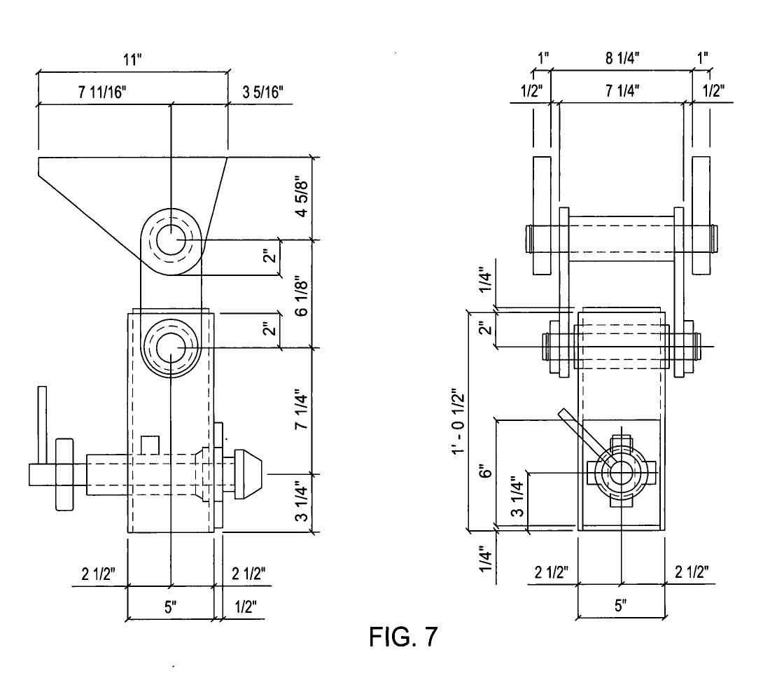

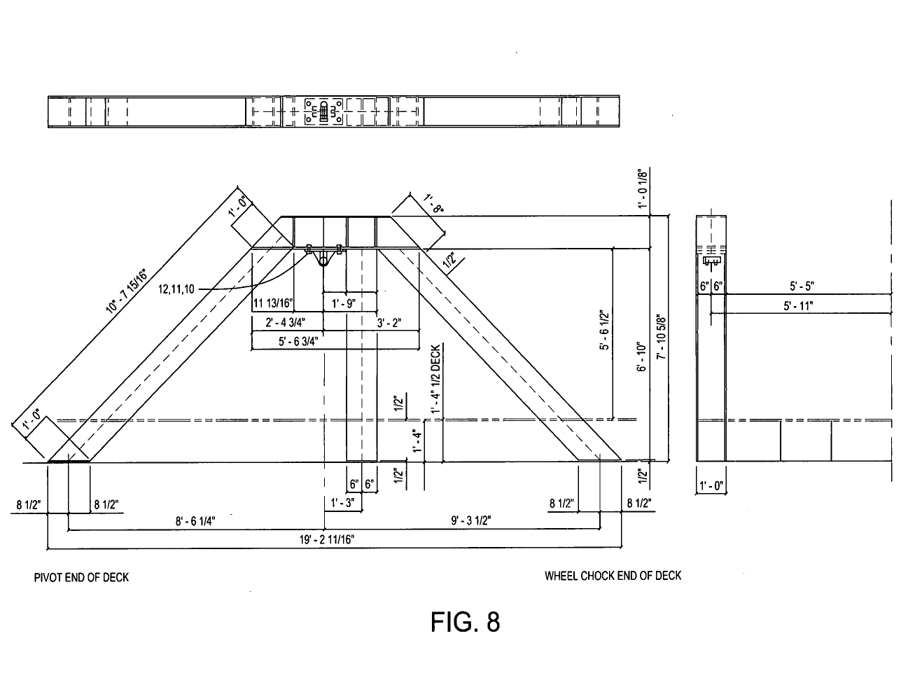

FIGS. 5-6 illustrate details of the container loader hydraulic backstop assembly 280, including the container lock assembly 270, which is depicted in more detail in FIG. 7. The container lock assembly 270 may include one or more screw locks. FIG. 8 shows detail of the A-frames 250 and exemplary dimensions of embodiments. The dimensions of components shown in FIGS. 5-8 and the other figures are merely exemplary and are not limiting to dimensions of components of embodiments.

Advantageously, embodiments disclosed herein may be semi-portable or may be fully portable and semi-portable.

In operation, the backstop (which may be hydraulically powered) of the backstop assembly 280 is raised to the full up position to allow the container and chassis to back onto the container tilter 10 until the chassis tires 235 make contact with the one or more wheel stops 240. As previously mentioned, advantageously, the container does not have to be removed from the chassis to back it onto the container tilter 10 due to the moveable backstop assembly 280. The hydraulic backstop preferably allows for clearance of both standard height (e.g., 8-foot, 6 inch) containers 255A and high or tall (e.g., 9-foot, 6-inch) containers 255B.

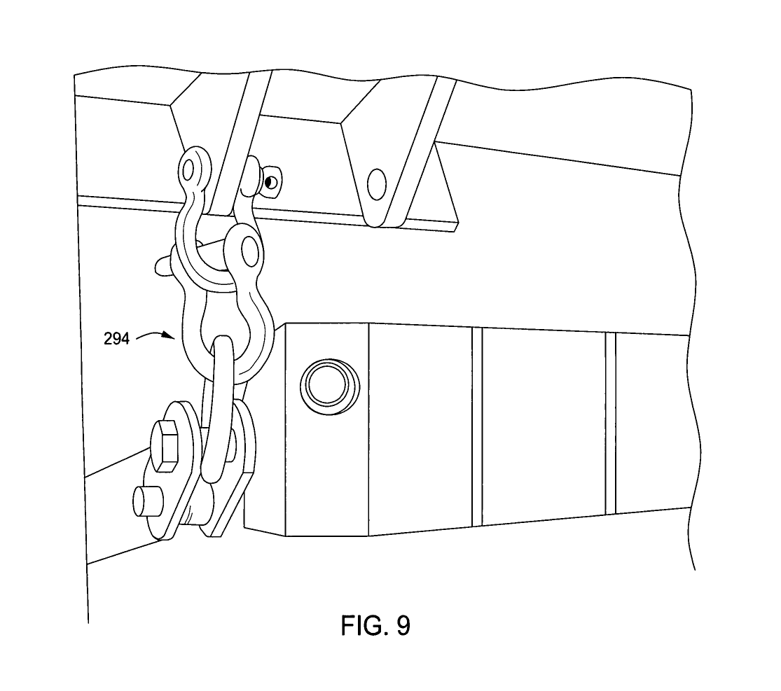

Once the container and chassis are properly positioned in the container tilter 10 on the deck platform 14, the hydraulic backstop may be lowered as needed to line up container twist locks to the bottom container locking corners. The twist locks, preferably two twist locks, are inserted and secured in each of the bottom container locking corners to lock, for example, at 210. In addition or in lieu of the twist locks, the container may be secured to the backstop assembly 280 via one or more container locking links 294, 296 (see FIG. 9), which may include a first locking link 294 at one end of the container and a second locking link 296 at the opposite end of the container. Of course, any other connecting member or method known to those skilled in the art for securing one member relative to another member may be utilized in addition to or in lieu of the previously-mentioned locking members/links/twist locks, and the connecting member(s) may operatively connect the container to the deck and/or the backstop assembly.

The truck fifth wheel is unlocked, and the truck is pulled clear using the hydraulic backstop to support the container and chassis. The chassis landing gear may be lowered to support the container, or instead the hydraulic backstop may be utilized during the loading process.

The one or more container doors are opened. Optionally, a remotely operated door closer such as a hydraulically powered door closer, may be used to allow closing of the doors in the tilted position to prevent the spilling out of material from the doors. A hydraulically powered door closer and opener may include one or more hydraulic piston/cylinder arrangements operatively connected to the door. (Optionally, the doors may also be opened remotely during or after tilting of the deck platform 14.)

The tilting deck platform 14 is then raised by pivoting it to the desired angle for loading material into the container. Although any range of angles between the sub-frame 12 and deck 14 are contemplated by the inventors, in one embodiment the possible angles at which the deck 14 may be tilted relative to the sub-frame 12 may range from 0 to approximately 90 degrees. In one exemplary embodiment, the deck 14 is tilted approximately 20 degrees relative to the sub-frame 12.

Of course, the deck platform 14 may be tilted prior to opening the one or more doors in an alternate embodiment.

The container is loaded with one or more materials (for example, by dropping the material into the container via a Caterpillar® or other container-loading apparatus known to those skilled in the art). During loading, the scale may optionally be operated in real time to selectively determine the weight of material within the container at various time increments or may continually determine the weight of the material within the container. Weight (and/or other measurements) may be shown on the readout panel and digital indicator. By showing the weight of material within the container while the container is being loaded, the user is not required to remove the container from the container tilter 10 and place the container on a separate scale to determine if the proper weight of material is disposed within the container. The dual shear load pins located at the main pivot point and bottom cylinder mounts ultimately allow the user to measure the approximate weight of the container while it is being loaded, as the dual shear load pins are operatively connected to a scale system.

Once the container is loaded to the desired weight, the deck 14 may be lowered (e.g., to the full down position) via pivoting the deck 14 relative to the sub-frame 12. The container doors are closed and secured. (In an alternate embodiment, the one or more container doors may be closed and secured prior to lowering the deck 14.) If necessary, the backstop is raised to achieve the correct height to align the chassis kingpin and the truck's fifth wheel. The truck is backed up until the fifth wheel locks to the chassis. The twist locks are unlocked from the container corners, and the backstop is raised to the full up position. The truck may now be operated to pull the container and chassis from the container tilter 10.

This paragraph describes one merely exemplary embodiment which is not intended to be limiting to embodiments. In this embodiment, a distance from a top end of the slide gate 260 to a lower end of the sub-frame 12 is approximately 23 feet 11⅛ inches in the position for loading the container onto the deck 14, and this distance is approximately 19 feet 3¾ inches when the container is ready to be raised on the container tilter 10 for loading. The fixed ramp is approximately 24 feet 1 7/16 inches in length, the container tilter 10 length is approximately 66 feet ½ inch, a distance from the bottom cylinder mounts 220 to a line through a center of the A-frames 250 is approximately 6 feet 1½ inch, a pivot radius from the pivot point 200 to the end of the sub-frame is approximately 19 feet 6 inches, and a distance from an end of the sub-frame 12 opposite the backstop assembly 280 and the end 14B of the deck 14 is approximately 1 foot 11½ inches. When pivoted to load the container in this example, an upper end of the container opposite the backstop assembly 280 may be approximately 44 feet 2 inches from the lowermost surface of the sub-frame 12 (see D1), and a lower end of the container opposite the backstop assembly 280 may be approximately 39 feet 3 inches from the lowermost surface of the sub-frame 12 (see D2). The load pin 298 may include the specifications shown in FIG. 4. In addition, the dimensions of the load pin 298 may optionally include the following approximate values: D3 may be approximately 13.63 inches, D4 may be approximately 3.245 to approximately 3.248 inches, D5 may be approximately 7.25 inches, D6 may be approximately 2.5 inches, D7 may be approximately 0.56 inches, D8 may be approximately 1.75 inches, D9 may be approximately 2.13 inches, and D10 may be approximately 0.5 inches. Referring to FIG. 5, the following approximate dimensions may be present in one example of the backstop assembly 280: D11 may be approximately 9 feet 8 inches (stroke length), D12 may be approximately 11 feet 2 inches (closed length), D13 may be approximately 10 feet 7½ inches, D14 may be approximately 11 feet 7½ inches (minimum keep inside beam uprights), D15 may be approximately 12 feet six inches, D16 may be approximately 7 feet (bottom of the backstop may weld to deck at the end), D17 may be approximately 9 feet 9⅝ inches (this may constitute a separate section), D18 may be approximately 10 feet 11½ inches (this may also constitute a separate section), and A1 may be approximately 45 degrees.

Generally, embodiments include a container tilter which allows a container attached to the chassis to be tilted and loaded with material without requiring removal of the container from the container tilter. The deck platform within a sub-frame design allows the container and chassis to roll on the deck platform so that the container does not have to be removed or turned around during the tilting and material loading operation. In embodiments, the gate/backstop (which may be hydraulic) and pivotable deck within a sub-frame design are included to aid in accomplishing these goals.

Embodiments shown and described herein advantageously allow a user to leave the container attached to the chassis when the unit is lifted to be loaded with material, thereby saving time, decreasing expense, and increasing efficiency of the container loading operation. Furthermore, embodiments shown and described herein permit loading of the container without requiring the container to be removed from the container tilter and turned around 180 degrees, also saving time, decreasing expense, and increasing efficiency of the container loading operation. Additionally, embodiments allow weighing of the material within the container without requiring removal of the container from the container tilter, also saving time, decreasing expense, and increasing efficiency of the operation.

While the foregoing is directed to embodiments of the present invention, other and further embodiments of the invention may be devised without departing from the basic scope thereof, and the scope thereof is determined by the claims that follow.

1. An apparatus for loading one or more materials in a container disposed on a chassis, comprising:
a sub-frame;
a deck pivotally connected to the sub-frame;
one or more members for pivoting the deck relative to the sub-frame; and
an adjustable backstop assembly operatively connected to the deck for selectively retaining the container on the deck when a container and chassis are disposed on the deck and the deck is pivoted relative to the sub-frame.

2. The apparatus of claim 1, wherein the backstop assembly is capable of allowing the container to enter through the backstop assembly in a first position and is capable of retaining the container on the deck when the deck is pivoted relative to the sub-frame in a second position.

3. The apparatus of claim 2, wherein the backstop assembly comprises a first supporting member which is pivotable relative to the sub-frame and a second supporting member which is slidable relative to the first supporting member.

4. The apparatus of claim 3, wherein the second supporting member is slidable from the first position to the second position using a powering mechanism.

5. The apparatus of claim 4, wherein the powering mechanism is hydraulic.

6. The apparatus of claim 3, wherein the second supporting member comprises at least one upright member and at least one cross member, the cross member capable of retaining the container on the deck when the backstop assembly is in the second position.

7. The apparatus of claim 2, wherein the backstop assembly is moveable between the first and second positions hydraulically.

8. The apparatus of claim 1, wherein the one or more materials are loadable into the container when the deck is pivoted relative to the sub-frame with the chassis remaining attached to the container.

9. The apparatus of claim 8, wherein the one or more materials are loadable onto the container with only one locating of the container and chassis on the deck.

10. The apparatus of claim 1, further comprising:
one or more weighing mechanisms operatively connected to the apparatus for determining a weight of the one or more materials while the container is disposed on the deck.

11. The apparatus of claim 10, wherein the one or more weighing mechanisms determine the weight in real time.

12. The apparatus of claim 11, wherein the one or more weighing mechanisms are integral to the apparatus.

13. The apparatus of claim 12, wherein the one or more weighing mechanisms comprise one or more load pins disposed at or near a pivot point of the deck relative to the sub-frame.

14. A method of loading one or more materials into a container disposed on a chassis, comprising:
providing a container tilting apparatus comprising:
a sub-frame,
a deck pivotally connected to the sub-frame,
a pivoting member for pivoting the deck relative to the sub-frame, and
a backstop assembly moveable between a first position and a second position;
moving the container and chassis onto the deck through the backstop assembly while the backstop assembly is in the first position;
moving the backstop assembly from the first position to the second position;
pivoting the deck relative to the sub-frame using the pivoting member; and
retaining the container and chassis on the deck using the backstop assembly in the second position.

15. The method of claim 14, further comprising loading one or more materials into the container.

16. The method of claim 15, further comprising loading the one or more materials into an opposite end of the container from an end of the container retained by the backstop assembly.

17. The method of claim 15, further comprising weighing the one or more materials while the deck is pivoted relative to the sub-frame.

18. The method of claim 14, wherein the backstop assembly comprises a first supporting member which is generally stationary relative to the deck and a second supporting member moveable relative to the first supporting member between the first position and the second position, wherein the second supporting member is moveable relative to the first supporting member using hydraulic power.

19. An apparatus for loading one or more materials in a container disposed on a chassis, comprising:
a sub-frame;
a deck pivotally connected to the sub-frame;
one or more members for pivoting the deck relative to the sub-frame; and
an adjustable backstop assembly operatively connected to the deck for selectively retaining the container on the deck, the backstop assembly comprising:
a support member which is generally stationary relative to the deck, and
a slide member which is slidable relative to the support member between a first position and a second position,
the slide member capable of retaining the container on the deck upon pivoting of the deck relative to the sub-frame when the slide member is in the first position.

20. The apparatus of claim 19, wherein the slide member is movable between the first and second position using hydraulic power.
